(19) United States
(12) Patent Application Publication
(10) Pub. No.: US 2013/0008977 A1
(43) Pub. Date: Jan. 10, 2013

(54) SYSTEM AND METHOD FOR CONTROLLING OPERATION OF AN IRRIGATION SYSTEM END GUN

(75) Inventors: Jochen Pfrenger, Omaha, NE (US); Thomas J. Korus, Lindsay, NE (US); Aaron Sauser, Tilden, NE (US)

(73) Assignee: Lindsay Corporation, Omaha, NE (US)

(21) Appl. No.: 13/176,454

(22) Filed: Jul. 5, 2011

(51) Int. Cl. A01G 27/00

(52) U.S. Cl. 239/69

(57) ABSTRACT

A control system for controlling operation of an irrigation system end gun includes memory for storing end gun operating parameters for a plurality of locations in an area to be irrigated; a location determining component for determining a current location of the end gun in the area to be irrigated; a computing device in communication with the location determining component and operable to access an end gun operating parameter from the memory that corresponds to the current location of the end gun; and an end gun control mechanism responsive to the computing device for controlling operation of the end gun in accordance with the end gun operating parameter.

### BACKGROUND OF THE INVENTION

1. Field of the Invention

The present invention relates to agricultural irrigation systems. More particularly, the invention relates to a system and method for controlling operation of an irrigation system end gun.

2. Background

Agricultural irrigation systems such as central pivot irrigation machines are commonly used to irrigate crops. A central pivot irrigation machine typically includes, among other things, a central pivot communicating with a pressurized water supply and a series of mobile support towers connected to the central pivot and to one another by truss-type framework sections. The mobile support towers are supported on wheels that are driven by a motor on each tower. A water distribution conduit is supported by the framework sections and a number of sprinkler heads, spray guns, drop nozzles, or other fluid-emitting devices are spaced along the length of the conduit.

Many irrigation systems also include one or more high pressure sprayers, commonly referred to as “end guns”, mounted to or near their end towers for watering the corners of fields or other areas that can't be easily reached by the irrigation systems.

### SUMMARY

Applicant has discovered that it is often desirable to change the settings of an end gun for different portions of an area being irrigated. For example, it may be desirable to have a longer water throw distance for some corners of a field but a lesser throw distance for other corners. Similarly, it may be desirable to reduce spraying of areas that are adjacent roads, buildings, etc. to avoid over-spraying water on the roads and buildings.

The coverage of an end gun can be selected by adjusting its arc settings (or stops), trajectory angle, nozzle setting, and/or other settings. Unfortunately, with known irrigation systems, these settings must be adjusted manually before system start-up and cannot be easily changed. Thus, many operators adjust the settings to accommodate the smallest area to be irrigated by the end guns and thus under-irrigate larger areas. Similarly, operators often adjust the settings to avoid over-spraying of areas with nearby roads, buildings, etc. and thus under-irrigate areas with no such obstacles.

Applicant has also discovered that the coverage of an end gun can be greatly affected by wind. For example, a stiff wind can greatly reduce the coverage of an end gun spraying into the wind and cause over-spraying when spraying in the same direction as the wind.

Embodiments of the present invention solve these problems by providing an end gun control system that automatically adjusts the settings of an end gun for different locations within a field or other area being irrigated. Other embodiments of the control system modify or override the settings based on wind speed or direction or other weather conditions.

An embodiment of the control system comprises memory for storing end gun operating parameters for a plurality of locations in a field or other area to be irrigated; a location determining component for determining a current location of the end gun in the area to be irrigated; a computing device in communication with the location determining component and the memory, and an end gun control device such as an arc adjustment mechanism or trajectory adjustment mechanism. The computing device is operable to access the memory and retrieve an end gun operating parameter that corresponds to the current location of the end gun. The computing device then instructs the end gun control device to control operation of the end gun in accordance with the end gun operating parameter so that the end gun can be operated differently for different locations within a field.

Other embodiments of the control system may also include a sensor for sensing a weather condition such as wind speed or direction. The computing device is responsive to the sensor and may modify or override an end gun operating parameter in response to the sensed weather condition. For example, the computing device may alter the trajectory of the end gun and/or its arc settings for a particular portion of a field based on the sensed wind speed and direction.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures. For example, the principles of the present invention are not limited to central pivot irrigation systems, but may be implemented in other types of irrigation systems including linear move irrigation systems.

### BRIEF DESCRIPTION OF THE DRAWING FIGURES

Embodiments of the present invention are described in detail below with reference to the attached drawing figures, wherein:

FIG. 1 is a perspective view of an exemplary central pivot irrigation system on which aspects of the present invention may be implemented.

FIG. 2 is a block diagram of an end gun control system constructed in accordance with an embodiment of the invention.

FIG. 3 is a schematic plan view showing a path of the irrigation system in a field being irrigated.

FIG. 4 is a schematic plan view showing an exemplary coverage pattern of the irrigation system and its end gun when the end gun is operated in a prior art manner.

FIG. 5 is another schematic plan view showing an exemplary coverage pattern of the irrigation system and a pair of end guns when operated in a prior art manner.

FIG. 6 is a schematic plan view showing an exemplary coverage pattern of the irrigation system and an end gun when controlled by the end gun control system of the present invention.

FIG. 7 is another schematic plan view showing an exemplary coverage pattern of the irrigation system and an end gun when controlled by the end gun control system of the present invention.

Embodiments of the present invention solve this problem by providing an end gun control system that permits the settings of an end gun to be adjusted for different areas in the field and/or for changing weather conditions.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

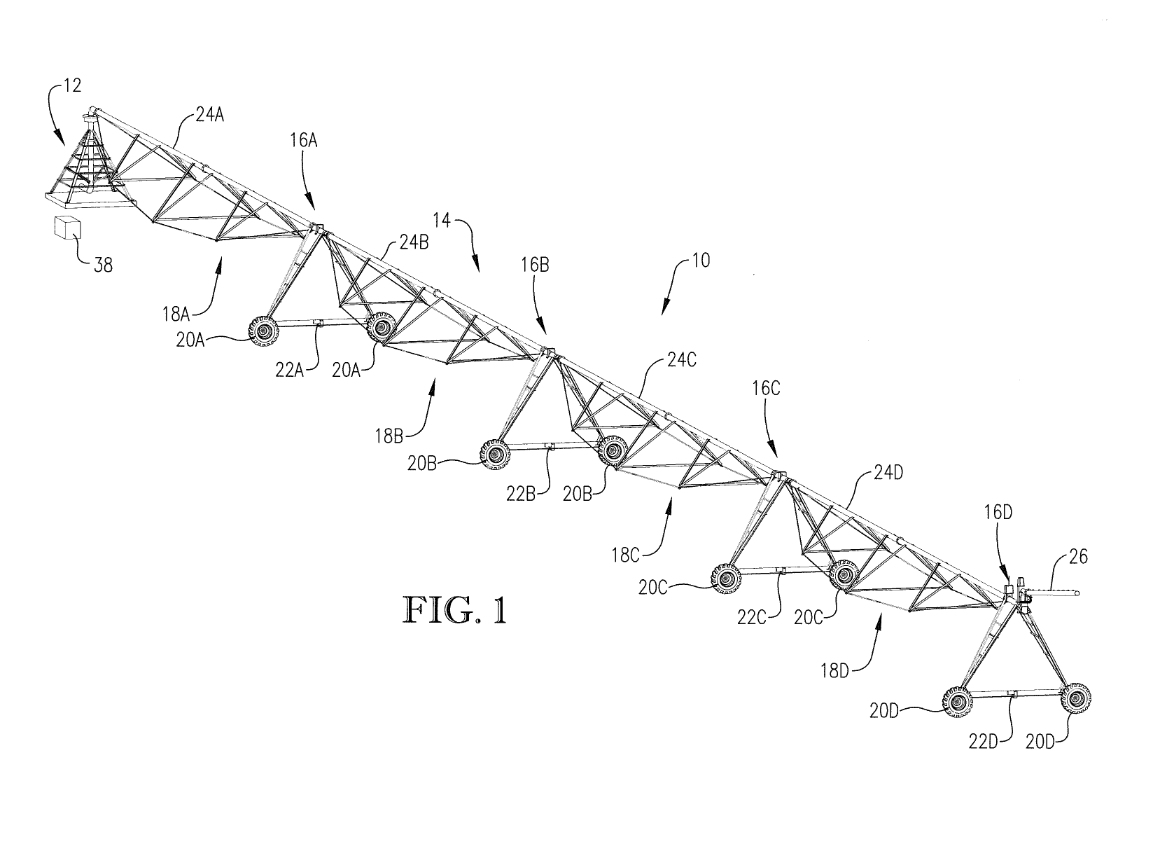

Turning now to the drawing figures, and initially FIG. 1, an exemplary irrigation system 10 on which principles of the present invention may be implemented is illustrated. An embodiment of the irrigation system 10 is a central pivot irrigation system and broadly comprises a fixed central pivot 12 and a main section 14 pivotally connected to the central pivot. Although a central pivot type irrigation system is described and illustrated herein, the principles of the present invention work equally well with other types of irrigation systems such as lateral move systems.

The fixed central pivot 12 may be a tower or any other support structure about which the main section 14 may pivot. The central pivot has access to a well, water tank, or other source of water and may also be coupled with a tank or other source of agricultural products to inject fertilizers, pesticides and/or other chemicals into the water for application during irrigation.

The main section 14 may comprise any number of mobile support towers 16A-D, the outermost 16D of which is referred to herein as an end tower. The support towers are connected to the fixed central pivot 12 and to one another by truss sections 18A-D or other supports to form a number of spans.

The mobile towers have wheels 20A-D, at least one of which is driven by suitable drive motors 22A-D. Each motor 22A-D turns at least one of its wheels 22A-D through a drive shaft to move its mobile tower and thus the main section in a circle about the central pivot to irrigate a field. The operation of the motors is controlled by methods readily known in the art.

Although not required, some or all of the towers 16A-D may be equipped with steerable wheels pivoted about upright axes by suitable steering motors so that the towers can follow a predetermined track. U.S. Pat. No. 4,508,269 in the name of Davis et al. is hereby incorporated by reference in its entirety into the present specification for a disclosure of ground drive motors and steering motors associated with an irrigation machine. As is also well known, the drive motors for the towers are controlled by a suitable safety system such that they may be slowed or completely shut down in the event of the detection of an adverse circumstance, all of which is disclosed, for example, in U.S. Pat. No. 6,042,031 to Christensen, et al. incorporated herein by reference in its entirety.

Each of the truss sections 18A-D carries or otherwise supports a conduit section 24A-D or other fluid distribution mechanism that is connected in fluid communication with all other conduit sections. A plurality of sprinkler heads, spray guns, drop nozzles, or other fluid-emitting devices are spaced along the conduit sections 24A-D to apply water and/or other fluids to land underneath the irrigation system.

The irrigation system also includes an extension arm (not shown) pivotally connected to the end tower and may be supported by a swing tower with steerable wheels driven by a motor. The extension arm may be joined to the end tower by an articulating pivot joint. The extension arm is folded in relative to the end tower when it is not irrigating a corner of a field and may be pivoted outwardly away from the end tower while irrigating the corners of a field.

The irrigation system 10 also includes one or more high pressure sprayers or end guns 26 mounted to the end tower 16D or to the end of the extension arm. The end guns are activated at the corners of a field or other designated areas to increase the amount of land that can be irrigated as discussed in more detail below.

The irrigation system 10 also includes a main control system for controlling movement of the mobile towers 16A-D and operation of the fluid-emitting devices in accordance with an irrigation program. The main control system may include a processor or other computing device with inputs that receive positional information from one or more GPS receivers mounted to the end tower or elsewhere. The processor may alternatively receive position information from angle encoders mounted between the central pivot and a first span of the main section. The processor may also include outputs connected to relay-controlled valves connected to the water-emitting devices and to relays connected to the electric motors 22A-D connected to the drive wheels of the mobile towers.

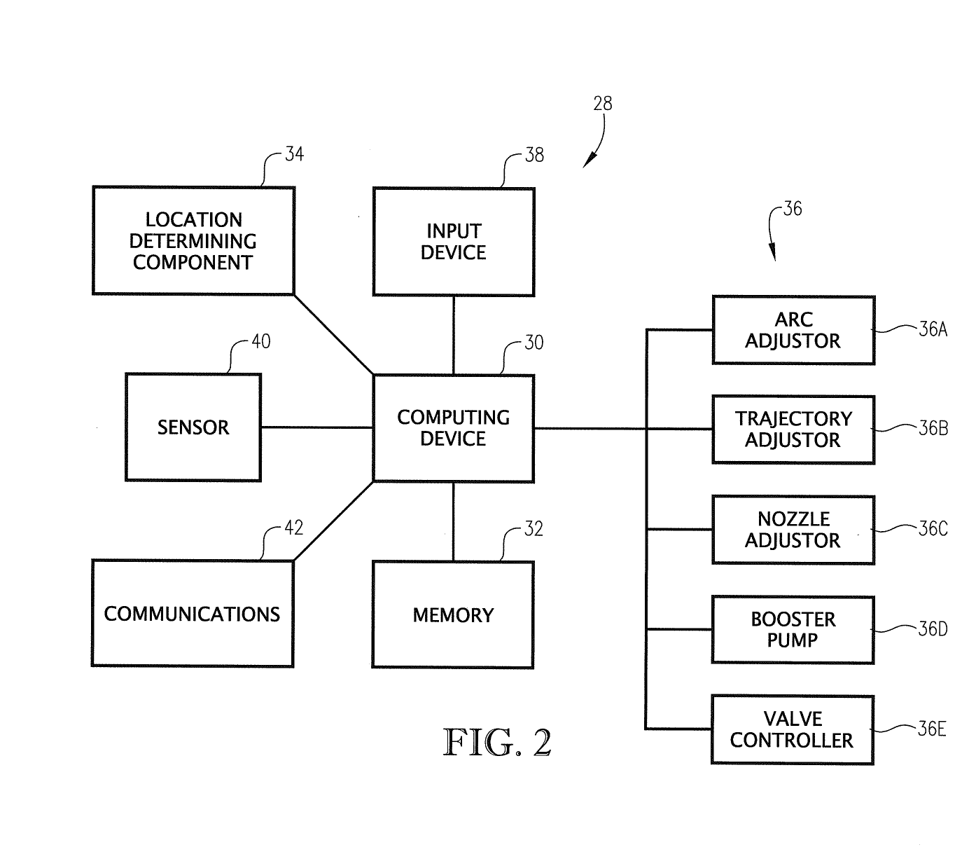

In accordance with aspects of the present invention, the irrigation system 10 also includes a control system 28 for controlling operation of the end guns 26. The control system 28 can be implemented with hardware, software, firmware, or a combination thereof. One embodiment of the control system 28 is illustrated in FIG. 2 and broadly comprises a computing device 30, memory 32, a location-determining component 34, and an end gun control mechanism 36. Other embodiments of the control system 28 are described below.

Some or all of the functionality of the control system 28 may be performed by the main control system or vice versa. In other words, the irrigation system 10 may include a separate main control system and control system 28 or a single control system that integrates some or all of the functions of the main control system and control system 28.

The computing device 30 is in communication with the other components of the control system 28 and instructs the end gun control mechanism 36 to control operation of each of the end guns as explained in more detail below. The computing device 30 may comprise or include any number or combination of processors, controllers, ASICs, or other control circuitry. As mentioned above, the computing device 30 and other components of the control system 28 may be part of the main control system so that a separate dedicated control system is not required.

A computer program that may be implemented by the computing device 36 may perform some of the control functions described herein. The computer program preferably comprises an ordered listing of executable instructions for implementing logical functions in the computing device. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The memory 32 may be any electronic memory that can be accessed by the computing device 30 and operable for storing instructions or data. The memory 32 may be integral with the computing device 30 or may be external memory accessible by the computing device. The memory may be a single component or may be a combination of components that provide the requisite functionality. The memory may include various types of volatile or non-volatile memory such as flash memory, optical discs, magnetic storage devices, SRAM, DRAM, or other memory devices capable of storing data and instructions. The memory may communicate directly with the computing device or may communicate over a bus or other mechanism that facilitates direct or indirect communication. The memory may optionally be structured with a file system to provide organized access to data existing thereon.

In accordance with one important aspect of the invention, the memory 32 or other memory may store data representative of end gun operating parameters for a plurality of locations in a field or other area to be irrigated by the irrigation system 10. The end gun operating parameters may include, for example, end gun arc settings or stops, trajectory settings, nozzle settings, water pressure settings, and water flow rate settings for each end gun on the irrigation system. The operating parameters may apply to particular zones or regions in a field to be irrigated. For example, each corner of a field may have different end gun operating parameters so that the end guns may be operated differently for each corner as described in more detail below. Alternatively, the operating parameters may apply to specific locations in a field such that many different discrete locations in the field may have their own unique end gun operating parameters.

The end gun control system 28 may also include an input device 38 for permitting an operator to input the end gun operating parameters into the memory. The input device may be an alphanumeric keypad, a USB port, or any other input device or port that permits the manual or automatic entry of end gun operating parameters and other data into the computing device. The control system 28 may also include a display and other components.

The location-determining component 34 determines, in a substantially conventional manner, location or orientation information for the portion of the main section on which the end guns are mounted. The location-determining component 34 may be any device capable of determining the main section's position or orientation. The location-determining component may be, for example, an angle encoder positioned between the fixed central pivot 12 and the main section 14 for sensing an angle between the main section and an axis line such as North. In some embodiments, the angle encoder is incorporated in an existing articulating joint positioned between the central pivot 12 and the first span of the main section so that the control system 28 does not require its own dedicated angle encoder.

The location-determining component 34 may also be a global navigation satellite system (GNSS) receiver such as a GPS receiver, Glonass receiver, Galileo receiver, or Compass system receiver attached to or near the end tower 16D and operable to receive navigational signals from satellites to calculate a position of the end tower and thus the end gun as a function of the signals. The GNSS receiver may include one or more processors, controllers, or other computing devices and memory for storing information accessed and/or generated by the processors or other computing devices. In some embodiments, the GNSS receiver is incorporated in the main control system so that the control system 28 does not require its own dedicated GNSS receiver. The GNSS receiver may be coupled with a GNSS patch antenna, helical antenna, or any other type of antenna mounted on or near the end tower.

The location-determining component 34 may also be any other receiving device capable of receiving location information from at least three transmitting locations and performing basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit.

The end gun control mechanism 36 may be any device capable of adjusting or otherwise controlling some setting or operational aspect of the end guns when instructed by the computing device 30. The end gun control mechanism 36 may include, for example, an arc adjustment mechanism 36A for adjusting an arc setting or stop of each end gun. Such a mechanism may include a servo motor, solenoid, or other mechanism capable of moving or otherwise adjusting the arc limits or stops of each end gun. The end gun control mechanism may also include a trajectory adjustment mechanism 36B for adjusting the trajectory of each end gun. Again, each a mechanism may include a motor, solenoid, or any other actuator for adjusting the height or spray angle of each end gun. The end gun control mechanism may also include a nozzle adjustment mechanism 36C for adjusting a nozzle setting of each end gun, a booster pump 36D for increasing the water pressure of each end gun, or a valve controller 36E for modulating or otherwise adjusting the water flow rate to each end gun.

Some or all of the components of the control system 28 may be enclosed in or supported on a weatherproof housing for protection from moisture, vibration, and impact. The housing may be positioned anywhere on or near the central pivot 12 and may be constructed from a suitable vibration- and impact-resistant material such as, for example, plastic, nylon, aluminum, or any combination thereof and may include one or more appropriate gaskets or seals to make it substantially waterproof or resistant.

The above-described components of the control system 28 need not be physically connected to one another since wireless communication among the various depicted components is permissible and intended to fall within the scope of the present invention.

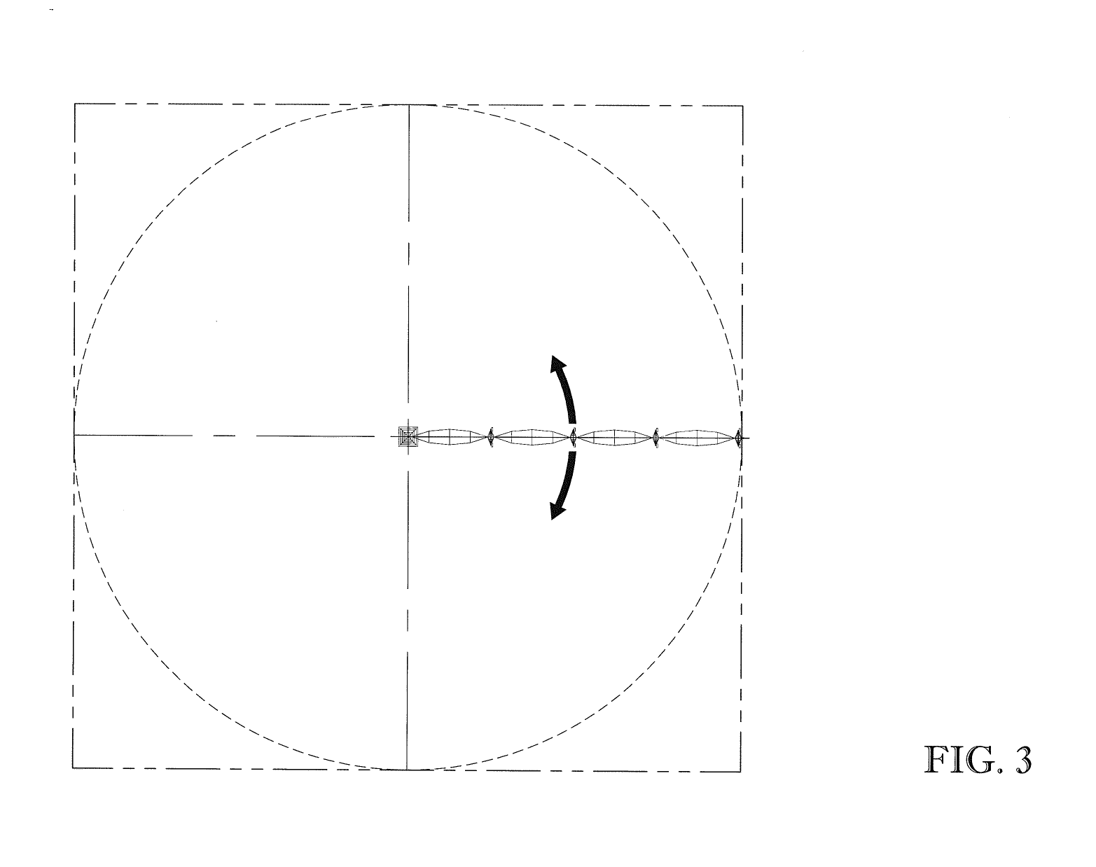

Operation of the irrigation system and the control system 28 will now be described with reference to FIGS. 3-7. The main control system controls operation of the motors 22A-D to move the spans of the irrigation system in a generally circular pattern as shown in FIG. 3. The control system 28 controls operation of each end gun on the irrigation system so as to maximize its coverage in the corners of the field and other hard to ready areas while reducing over-spraying onto roads, buildings, etc. Although the control system 28 may control any number of end guns, the operation of only one end gun is discussed in detail herein for clarity.

When the irrigation system is in use, the computing device 30 continuously or periodically determines the current position of the end gun 26 or the tower to which it is mounted by receiving location information from the location-determining component 34. The computing device 30 then compares the end gun's current location to the stored locations in the memory 32 and retrieves end gun operating parameters from the memory whenever the current location matches a stored location. For example, when the end gun 26 approaches a first corner of a field being irrigated, the computing device may retrieve end gun operating parameters specific to the corner. Such end gun operating parameters may include arc stops/limits or other arc settings, end gun trajectory settings, nozzle settings, water pressure settings, water flow rate settings, etc. The end gun operating parameters may apply to the entire corner or for different locations within the corner. For example, the end gun arc stops/limits may be the same for the entire corner but the end gun trajectory, end gun nozzle settings, and water pressure may change for different locations within the corner.

The computing device 30 then instructs the end gun control mechanisms 36A-36E to implement the retrieved end gun operating parameters. For example, the computing device 30 may instruct the arc adjustment mechanism 36A to adjust the end gun's arc setting, the trajectory adjustment mechanism 36B to adjust the end gun's trajectory, the nozzle adjustment mechanism 36C to adjust the end gun's nozzle setting, the booster pump 36D to increase the end gun's water pressure, and/or the valve controller 36E to adjust the water flow rate to the end gun.

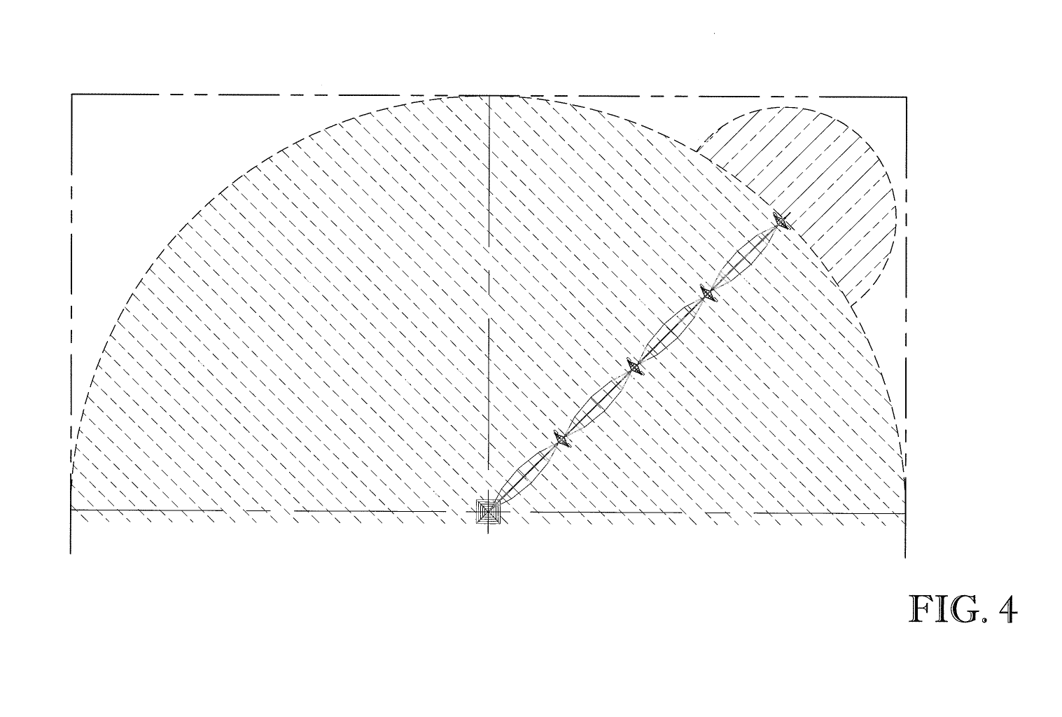

By adjusting the end gun operating parameters for different locations within a field or other the area being irrigated, the coverage of the end gun can be maximized without over-spraying onto areas not intended to be irrigated. FIG. 4 shows (in cross-hatching) the water coverage of an irrigation system and its end gun when the end gun is operated in a prior art manner with fixed arc settings, trajectory angles, and other settings. As shown, the end gun sprays in a generally semi-circular pattern with a fixed throw distance. To avoid over-spraying onto roads, power lines, buildings, and other obstacles adjacent the field, the end gun's settings have been adjusted so as not to spray water over the entire corner of the field. This results in some areas receiving too little or no water as shown.

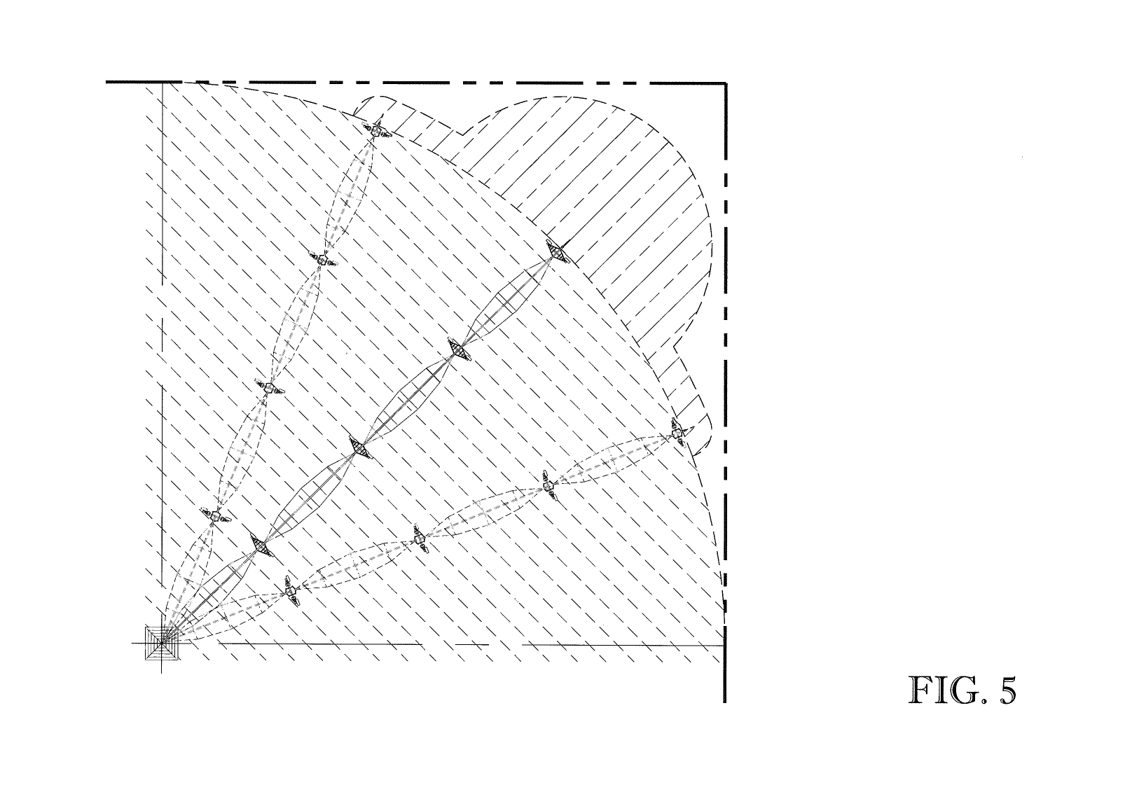

FIG. 5 shows the water coverage of an irrigation system with two end guns, one with a long throw distance and the other with a shorter throw distance, when the end guns are operated in a prior art manner with fixed arc settings, trajectory angles, and other settings. As shown, both end guns spray in a generally semi-circular or arcuate pattern. By using two ends guns, a greater percentage of the corner can be irrigated without over-spraying onto roads, power lines, buildings, and other obstacles. However, even with two end guns, some areas receive too little or no water as shown.

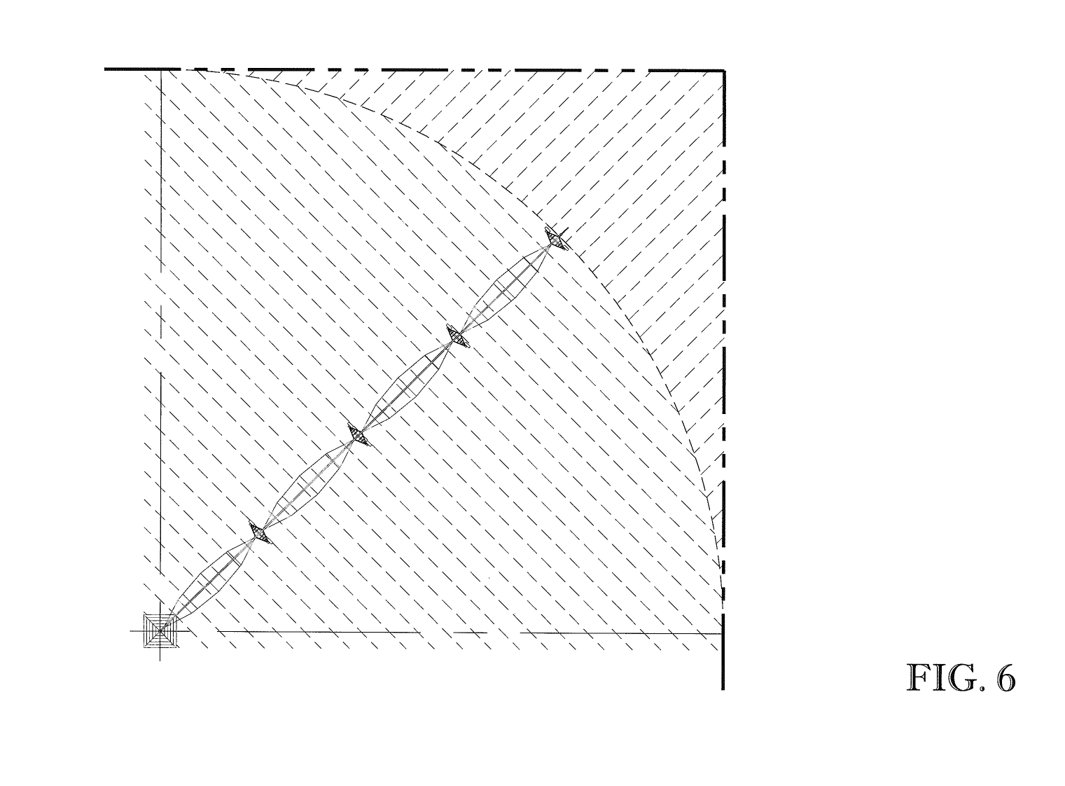

In contrast FIG. 6 shows the water coverage of an irrigation system with a single end gun when the end gun is controlled by the control system 28 of the present invention. As shown, by adjusting the end gun's arc settings, trajectory, booster pump, and other operating parameters for various locations within the corner, it is possible to irrigate virtually the entire corner without over-spraying onto nearby roads, buildings, etc.

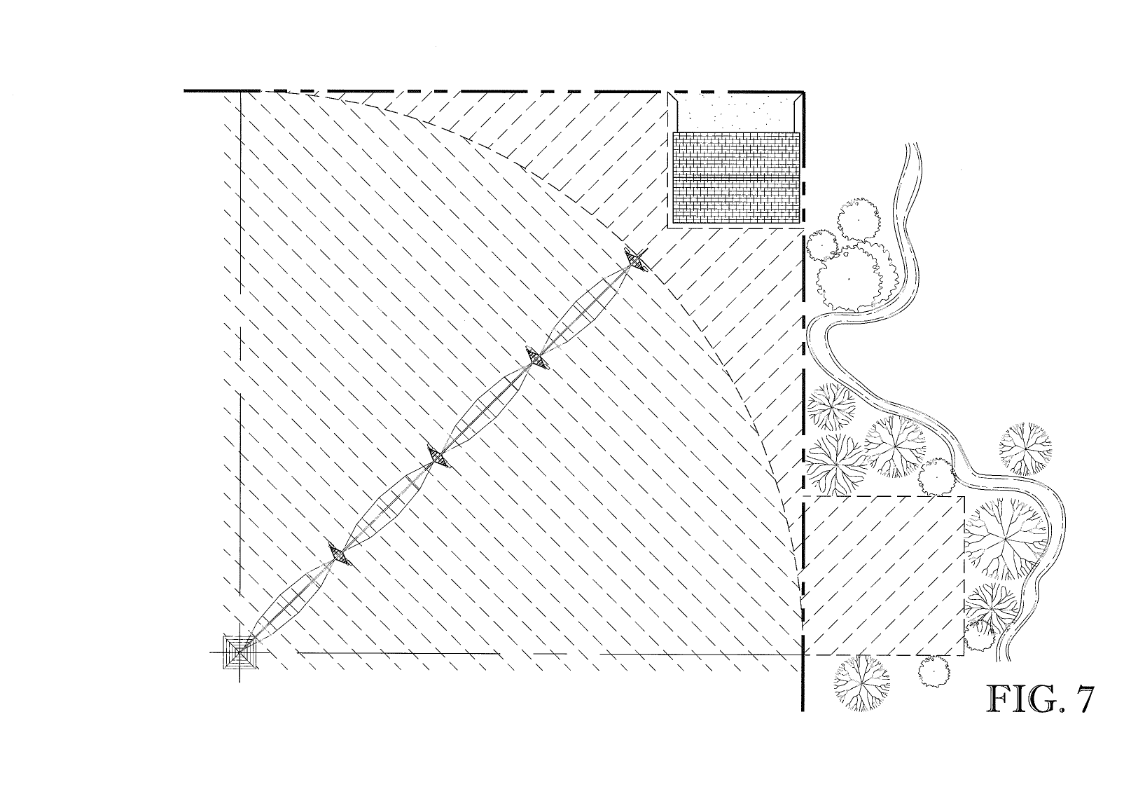

FIG. 7 shows another exemplary water coverage pattern of an irrigation system with one end gun when controlled by the control system 28. As shown, the coverage pattern does not have to be circular, but can be virtually any shape so as to avoid spraying buildings, etc.

Returning to FIG. 2, other embodiments of the control system 28 may also include a sensor 40 for sensing a weather condition. For example, the sensor 40 may be a wind sensor for sensing wind speed or wind direction. The wind sensor may be an analog or digital anemometer with wind direction sensing capability. The wind sensor may be mounted to the irrigation system 10 or may be mounted to a nearby pole or building. The wind sensor may be wired to the computing device or may communicate with it wirelessly. The computing device 30 is responsive to the sensor and may modify or override an end gun operating parameter in response to the sensed weather condition. For example, the computing device may alter the trajectory of the end gun and/or its arc settings for a particular portion of the field based on the wind speed and direction.

The control system may also include a communications device 42 operable to receive wind speed and direction data from an external source. The communications device 42 may be a radio receiver operable to receive weather data from a weather source.

Although the invention has been described with reference to the embodiments illustrated in the attached drawing figures, it is noted that equivalents may be employed and substitutions made herein without departing from the scope of the invention as recited in the claims. For example, the principles of the present invention are not limited to the illustrated central pivot irrigation systems but may be implemented in any type of irrigation system including linear move irrigation systems.

Having thus described the preferred embodiment of the invention, what is claimed as new and desired to be protected by Letters Patent includes the following:

1. A control system for controlling operation of an irrigation system end gun, the control system comprising:
memory for storing end gun operating parameters for a plurality of locations in an area to be irrigated;
a location determining component for determining a current location of the end gun in the area to be irrigated;
a computing device in communication with the location determining component and operable to access an end gun operating parameter from the memory that corresponds to the current location of the end gun; and
an end gun control mechanism responsive to the computing device for controlling operation of the end gun in accordance with the end gun operating parameter.

2. The control system of claim 1, wherein the end gun operating parameter is an arc setting of the end gun and wherein the end gun control mechanism is an arc adjustment mechanism for adjusting the arc setting.

3. The control system of claim 1, wherein the end gun operating parameter is a trajectory of the end gun and wherein the end gun control mechanism is a trajectory adjustment mechanism for adjusting the trajectory.

4. The control system of claim 1, wherein the end gun operating parameter is a nozzle setting for the end gun and wherein the end gun control mechanism is a nozzle adjustment mechanism for adjusting the nozzle setting.

5. The control system of claim 1, wherein the end gun operating parameter is a water pressure for the end gun and wherein the end gun control mechanism is a booster pump for increasing the pressure.

6. The control system of claim 1, wherein the end gun operating parameter is a water flow rate for the end gun and wherein the end gun control mechanism is a valve controller for adjusting the water flow rate to the end gun.

7. The control system of claim 1, further comprising a weather sensor for sensing a weather condition, the computing device being operable to modify or override the end gun operating parameters in response to the sensed weather condition.

8. The control system of claim 7, wherein the weather sensor is a wind sensor and the weather condition is wind speed or wind direction.

9. The control system of claim 1, wherein the irrigation system is a central pivot irrigation system or a lateral move irrigation system.

10. A control system for controlling operation of an irrigation system end gun, the control system comprising:
memory for storing end gun operating parameters for a plurality of locations in an area to be irrigated;
a location determining component for determining a current location of the end gun in the area to be irrigated;
a wind sensor for sensing wind speed and direction;
a computing device in communication with the location determining component and the wind sensor and operable to access an end gun operating parameter from the memory that corresponds to the current location of the end gun and to modify the end gun operating parameter in response to the sensed wind speed and direction; and
an end gun control mechanism responsive to the computing device for controlling operation of the end gun in accordance with the modified end gun operating parameter.

11. The control system of claim 10, wherein the end gun operating parameter is an arc setting of the end gun and wherein the end gun control mechanism is an arc adjustment mechanism for adjusting the arc setting.

12. The control system of claim 10, wherein the end gun operating parameter is a trajectory of the end gun and wherein the end gun control mechanism is a trajectory adjustment mechanism for adjusting the trajectory.

13. The control system of claim 10, wherein the end gun operating parameter is a nozzle setting for the end gun and wherein the end gun control mechanism is a nozzle adjustment mechanism for adjusting the nozzle setting.

14. The control system of claim 10, wherein the end gun operating parameter is a water pressure for the end gun and wherein the end gun control mechanism is a booster pump for increasing the pressure.

15. The control system of claim 10, wherein the end gun operating parameter is a water flow rate for the end gun and wherein the end gun control mechanism is a valve controller for adjusting the water flow rate to the end gun.

16. An irrigation system comprising:
a central pivot;
a main section pivotally connected to the central pivot;
an end gun positioned on the main section; and
a control system for controlling operation of the end gun, the control system comprising:
memory for storing end gun operating parameters for a plurality of locations in an area to be irrigated by the irrigation system;
a location determining component for determining a current location of the end gun in the area to be irrigated;
a computing device in communication with the location determining component and operable to access an end gun operating parameter from the memory that corresponds to the current location of the end gun; and
an end gun control device mechanism responsive to the computing device for controlling operation of the end gun in accordance with the end gun operating parameter.

17. The irrigation system as set forth in claim 16, wherein the main section comprises:
a series of mobile towers connected to the central pivot and to one another by support structure, each mobile tower having wheels and a motor for driving at least one of the wheels;
a water distribution conduit supported by the support structure; and
a number of fluid-emitting devices connected to the water distribution conduit.

18. The irrigation system as set forth in claim 17, further comprising a main control system for controlling movement of the mobile towers and operation of the fluid-emitting devices in accordance with an irrigation control program.

19. The irrigation system as set forth in claim 18, wherein the control system is part of the main control system.

20. An irrigation system comprising:
a series of mobile towers connected to one another by support structure, each mobile tower having wheels and a motor for driving at least one of the wheels;
a water distribution conduit supported by the support structure;
a number of fluid-emitting devices connected to the water distribution conduit;
an end gun connected to the water distribution conduit; and
a control system for controlling operation of the end gun, the control system comprising:
memory for storing end gun operating parameters for a plurality of locations in an area to be irrigated;
a location determining component for determining a current location of the end gun in the area to be irrigated by the irrigation system;
a wind sensor for sensing wind speed and direction;
a computing device in communication with the location determining component and the wind sensor and operable to access an end gun operating parameter from the memory that corresponds to the current location of the end gun and to modify the end gun operating parameter in response to the sensed wind speed and direction; and
an end gun control mechanism responsive to the computing device for controlling operation of the end gun in accordance with the modified end gun operating parameter.
